(19) United States
(12) Patent Application Publication
(10) Pub. No.: US 2008/0193192 A1
(43) Pub. Date: Aug. 14, 2008

(54) Device for Use with Waxed Boards

(76) Inventor: Paul Zulian, New South Wales (AU)

Correspondence Address: SMITH-HILL AND BEDELL, P.C., 16100 NW CORNELL ROAD, SUITE 220, BEAVERTON, OR, 97006, US

(21) Appl. No.: 11/913,763

(22) PCT Filed: May 25, 2006
(86) PCT No.: PCT/AU2006/000687

§ 371 Date: Nov. 6, 2007

(30) Foreign Application Priority Data
May 30, 2005 (AU) 2005902755

(51) Int. Cl. B05C 17/10

(52) U.S. Cl. 401/52

(57) ABSTRACT

A device for applying wax to, and removing wax from a board, comprises a parallelepiped block of wax contained within a stiff plastics sleeve. The sleeve is integrally formed with flaps at opposite ends and which are hinged to the sleeve and can be retained in positions at which they enclose the block inside the sleeve as shown. The sleeve has a tooth edge at one end for scoring wax on the board. The other end of the sleeve opposite the serrated edge has a sharp corner edge usable to remove unwanted wax from the board.

### FIELD OF THIS INVENTION

THIS INVENTION relates to a device for applying and removing wax from boards and is more specifically concerned, although not exclusively, with such a device for use with surf boards or snow boards.

### STATE OF THE ART

Surf board riders usually wax their boards to make them less slippery under foot when in use. After the board has been waxed on its upper surface, the wax is commonly scored on its face to provide a less slippery surface. Special waxes have been developed for use on surfboards and are sold in blocks at surf shops. Scorers having a serrated edge can also be purchased separately from the same shops and the surfer will normally keep the wax block and scorer in a plastics jar so that he can use them when required. The surfer may also keep a scraper in the same jar so that used wax can be scraped off the board and replaced by a fresh wax layer when required.

U.S. Pat. Specification No. 6,821,041 proposes that a device be provided to perform all three functions of applying wax to a board, scoring its surface and removing unwanted wax from the board. A cylindrical wax block is enclosed in a tubular sleeve having at one end a removable cap on which is mounted a toothed blade and a straight edge which extend outwardly from the cap in the direction of the axis of symmetry of the sleeve. The other end of the sleeve contains a pusher assembly engaging one end of the block. To use the device the removable cap is detached from the sleeve and the pusher assembly is used to force the block progressively from the sleeve so that it can be used to apply wax to the board. The removable cap is then replaced on the sleeve and the toothed blade can be used to score the applied wax and the straight edge can be used to remove unwanted wax.

The device described has many separately fabricated parts which necessarily increases its cost. Also the toothed blade and sharp straight edge are seemingly always exposed and are capable of causing serious injury to a person in the event of an accident.

### OBJECT OF THE INVENTION

An object of this invention is to provide an improved device for making the application and removal of wax from a board easier.

The Invention

In accordance with one aspect of the invention a device for applying wax to, and removing wax from a board, comprises, in combination: a waxing block for applying a layer of wax to one face of the board, an open-ended sleeve closely surrounding the sides of the waxing block to provide a handle for its use, movable closures provided respectively at opposite ends of the sleeve, a linear toothed or serrated first edge for scoring a wax layer applied by the block to the board, and a sharp second edge for removing unwanted wax from the face of the board; in which device the sleeve is of parallelepiped shape and each of said two edges lies in the plane of a flat side of the sleeve.

Advantages of the Invention

The invention has several advantages over the prior art proposal. It has fewer parts which require separate fabrication so that it can be made more cheaply. Also the use of a blade providing the two edges and protruding from one end of the device is avoided so that there is less risk of injury to the user in the event of an accident when the device is not in use. Finally, the device can be made by a plastics moulding process which enables it to be mass produced.

Preferred Features of the Invention

The device, when sold, may have the sleeve constructed as a casing to enclose and protect the block and may be designed provide the two edges opposite one another on the sleeve. The sleeve is conveniently provided at its open ends with hinged closure flaps for retaining the block wholly inside the sleeve when not in use. The flaps are suitably so arranged that they are positively located when in their closed positions but may be manually moved to their open positions to enable the block to be partially slid out of the sleeve to a position at which it can be used to wax the board.

In the preferred arrangement the device is made from a hard plastics material and the hinges for the flaps may comprise crease lines integrally moulded with the rest of the sleeve. The first and second edges are suitably formed on the sleeve when made of a hard material. Also there is no risk of the closures being mislaid through their being totally detached from the open-ends of the sleeve and placed on one side.

However it is also possible for the sleeve to made from cardboard. In this case the first and second edges may be provided on a hard plate accommodated alongside the block inside the sleeve, the plate being displaceable lengthwise of the open-ended sleeve so that its edges are available for use either to score the wax applied to the board or to remove unwanted wax from the board surface. It can then be returned to its position inside the sleeve.

The toothed or serrated first edge and the sharp corner second edge, may respectively be provided at the ends of the sleeve. As the sleeve is open-ended, when the device is to be used, the block can be manually pushed through it against the resistance of adhesion of the surfaces of the block with the interior surfaces of the sleeve. One end of the block can thus be made to protrude from the sleeve a desired distance so that it covers the toothed edge.

### INTRODUCTION TO THE DRAWINGS

The invention will now be described in more detail, by way of an examples, with reference to the accompanying largely diagrammatic drawings in which:

In the drawings

FIG. 1 is a perspective view from above of a closed sleeve providing a holder for a block of wax shown in broken outline and located within the sleeve;

FIG. 2 is a side view of the open sleeve of FIG. 1 and shows the waxing block partially protruding from one end of the sleeve;

FIG. 3 is an end view of the closed sleeve of FIG. 1, and is taken in the direction of the arrow “A” in that figure;

FIG. 4 is a detailed and enlarged view of some of a line of teeth provided at one end of the sleeve;

FIG. 5 is an end view of the closed sleeve of FIG. 1 as seen when viewed in the direction of the arrow “B”; and,

FIG. 6 is a plan view of a second embodiment of sleeve in which one pair of opposite side edges are respectively provided with shaped flanges enabling wax to be removed from concave and convex surfaces of the board.

### DESCRIPTION OF PREFERRED EMBODIMENT

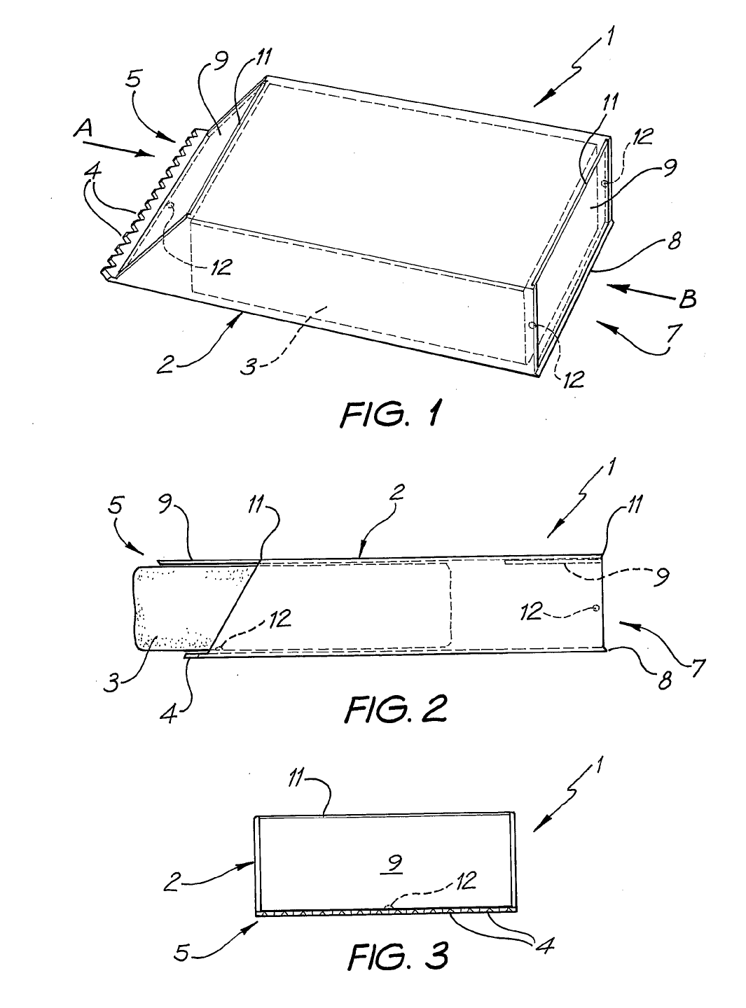

FIG. 1 shows a device 1 for applying wax to, and removing unwanted wax from a surf board. The device is in the form of an open-ended sleeve 2 of rectangular vertical section containing a block 3 of wax which is a tight push-fit in the sleeve 2. The block 3 can be manually forced out of a toothed end 5 of the sleeve 2 by finger pressure applied to its other end so that a portion of the block 3 to be used for waxing the surfboard protrudes from the sleeve as shown in FIG. 2.

The plastics sleeve is made from a hard plastics material by a moulding process and provides a handle for the device. The sleeve is provided at each end with a closure flap 9 connected along one edge to the sleeve 2 by hinges formed by crease lines 11. The hinging crease lines 11 and the flaps 9 are formed in the same moulding process as the sleeve 2. Dimples 12 are positioned inside the sleeve on its side walls where they can be used to hold the flaps 9 closed when the device is not being used and the wax block inside the sleeve needs to be protected.

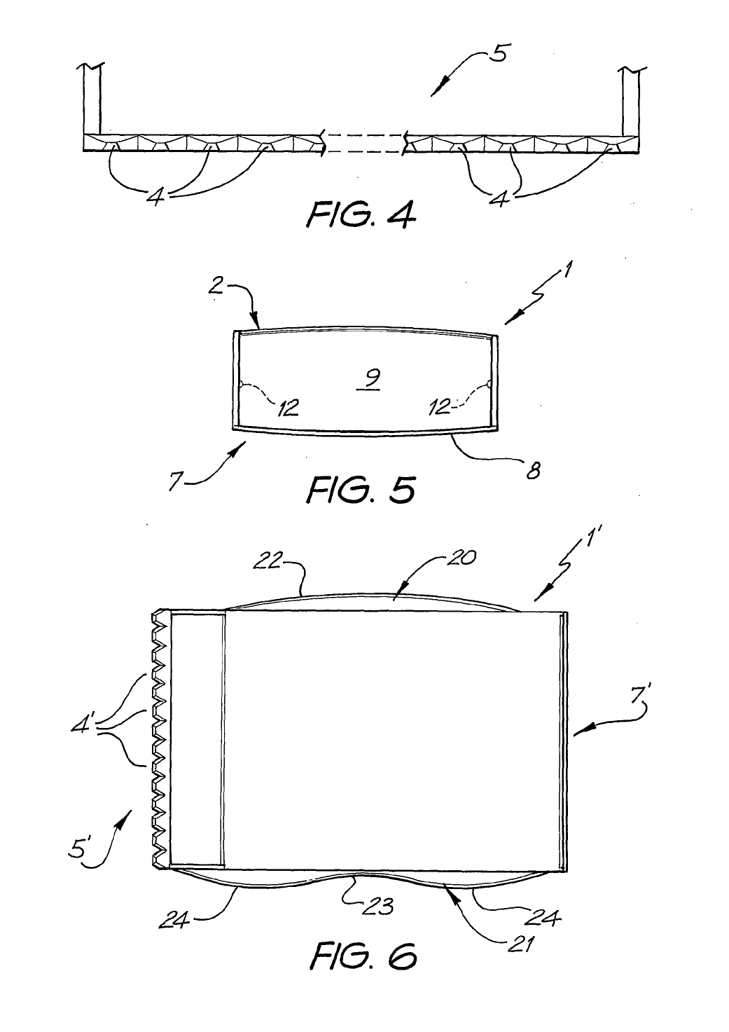

The sleeve 2 is of uniform vertical section throughout its length as is apparent from FIG. 3. The toothed end 5 of the sleeve 2 has a line of projecting teeth 4 which are of trapezoidal vertical section as shown in FIG. 4 and taper towards their ends as shown in FIG. 1. The purpose of the teeth 4 is to enable a wax layer applied to the surf board to be scored. If desired the toothed end 5 may be serrated or provided with smaller teeth than those shown in the drawings.

At its other end 7 the sleeve 2 is provided with a linear sharp edge 8 which can be used as a scraper for removing a used layer of wax from the board. This is carried out by the simple expediency of turning the sleeve 2 end-for-end. In both cases the sleeve 2 serves as a handle. It should be noted that the sleeve 2, after removal of the block 3, provides a convenient receptacle for retaining the wax scrapings removed from the board.

### Operation of the Preferred Embodiment

The device 1 is used as follows:

To apply wax to a board the block 3 is forced partly from the toothed end 5 of the sleeve 2 by finger pressure applied to its other end. This finger pressure is sufficient to move both of the flaps 9 from positions at which they engage behind the dimples 12, to the positions shown in FIG. 2.

The block 3 is moved sufficiently out of the sleeve 2 to cover the toothed end 5 of the sleeve 2. When waxing is completed, the block 2 is pushed back by finger pressure to the position shown in FIG. 1 at which the toothed edge 5 is exposed and the two flaps 9 can be returned to in their closed positions at opposite ends of the sleeve. The face of the waxed layer may then be scored by the teeth 4 to make it less slippery.

After a period of use, the scored wax layer may require removing from the board. This is carried out by using the slightly curved sharp edge 8 to scrape off unwanted wax. The sleeve 2 once again serves as a handle and as a container for the wax scrapings.

### Description of Second Embodiment Shown in FIG. 6

In order to save unnecessary repetition of description, parts of FIG. 6 similar in function to those already described with reference to earlier figures are similarly referenced except that the references are primed. These parts will not be again described.

The device 1′ of FIG. 6 is of the same general shape as that described with reference to earlier figures. However thin, flat flanges 20,21 extend away from the respective sides of the sleeve 2. These flanges have sharp edges and are integrally moulded with the sleeve 2′. One flange 20 has a convexly curved sharp peripheral edge 22 and the other flange 21 has two, spaced, convexly-curved, corner edges 24 so that a gently curved valley 23 is formed between them. The flanges are relatively thin so that they flex slightly when in use to enable wax to be removed from convex or concave surfaces of the board.

In an unillustrated variation of the device, the sleeve is of trapezoidal shape when viewed from the side and the closure flaps are respectively hinged to opposite ends of the shorter parallel side of the trapezium. The flaps thus slope downwardly away from one another at opposite ends of the sleeve, and notches on the sleeve engage detents on the flaps to retain the flaps in their open and closed positions. When the flaps are in their closed positions they close opposite ends of the open-ends of the sleeve. When the flaps are in their open positions they lie against opposite outside end-portions of the shorter parallel side of the sleeve.

An advantage of the invention is that the toothed edge is supported along its length by the rigidity of the linear corner of the sleeve from which it extends. It is thus much less likely to be damaged or to break part-way along its length when being used, than is the case when the toothed edge forms part of a cantilever as is described in the United States prior art specification mentioned above. Also the toothed edge can be moulded with the sleeve to reduce manufacturing costs. Although not specifically stated, the device described in the prior art specification would almost certainly have its various components manufactured from metal or glass fibre.

In this specification word “comprises” and “comprising” are used in the sense of meaning that the features of the combination set forth in the same sentence are the minimum features which must be present for carrying out the invention and not an exhaustive list of such features.

1-7. (canceled)

8. A device for applying wax to, and removing wax from a board, comprising:
a waxing block for applying a layer of wax to one face of the board,
an open-ended sleeve closely surrounding the sides of the waxing block to provide a handle for its use, movable closures provided respectively at opposite ends of the sleeve,
a linear toothed or serrated first edge for scoring a wax layer applied by the block to the board, and
a sharp second edge for removing unwanted wax from the face of the board;
in which device the sleeve is of parallelepiped shape and each of said two edges lies in the plane of a flat side of the sleeve.

9. A device as claimed in claim 8, in which the closures comprise respective flaps hinged to the sleeve and for protecting the waxing block when not in use.

10. A device as claimed in claim 9, in which the flaps have associated means provided on the sleeve for positively locating them in their closed and their open positions.

11. A device as claimed in claim 9, in which the sleeve is made from a hard plastics material and has at each end a crease line providing a hinge for a flap.

12. A device as claimed in claim 8, in which the parts of the sleeve providing the toothed or serrated rust edge and the sharp corner second edge, are respectively provided at opposite ends of tile sleeve and are formed integrally therewith by a moulding process.

13. A device as claimed in claim 8, in which the sleeve is of rectangular vertical section.

14. A device as claims in claim 8, in which the one side edge of the sleeve is provided externally with a flange having a convexly curved free edge, and the opposite side of the sleeve is provided with a flange having two spaced convexly curved portions along its edge and between which a curved valley is formed.
